(19) United States
(12) Patent Application Publication
(10) Pub. No.: US 2023/0057283 A1
(43) Pub. Date: Feb. 23, 2023

(54) SURFACE RELIEF GRATING AND METHOD OF MAKING THE SAME

(71) Applicant: Facebook Technologies, LLC, Menlo Park, CA (US)

(72) Inventors: Vivek Gupta, Sammamish, WA (US); Nihar Mohanty, Snoqualmie, WA (US); Jay Patel, Menlo Park, CA (US); Topalian Topalian, Seattle, WA (US)

(73) Assignee: Facebook Technologies, LLC, Menlo, CA (US)

(21) Appl. No.: 17/890,927

(22) Filed: Aug. 18, 2022

Related U.S. Application Data
(60) Provisional application No. 63/235,633, filed on Aug. 20, 2021.

(51) Int. Cl. G02B 5/18

(52) U.S. Cl. CPC G02B 5/1847; G02B 5/1809

(57) ABSTRACT

There is provided a method that includes depositing a plurality of layers in a substrate including a pattern. The plurality of layers can form a stack that includes at least two different materials. The stack thus forms a composite layer which has an effective index of refraction that is unique. The method may make use of at least two different materials, which can be a combination of aluminum oxide (A12O3), Titanium Dioxide (TiO2), and silicon dioxide (SiO2). These materials may be deposited via atomic layer deposition (ALD).

### CROSS-REFERENCE TO RELATED APPLICATIONS

This application claims benefit of United States Provisional Pat. Application, Serial Number 63/235,633, filed Aug. 20, 2021, the contents which is herein incorporated by reference in its entirety.

### BACKGROUND OF THE DISCLOSURE

With the advent of wearable devices that include optical elements, there is a need to adapt microfabrication processes to produce optical devices that can easily be integrated in small form factor systems. For example, for augmented reality or virtual reality headsets, there is a need for miniaturized gratings that can be used for light processing, filtering, and routing.

Current manufacturing techniques for such gratings are suited for discrete elements which may not easily be integrated in the contemplated small form factor devices. As such, there is a need for manufacturing processes that can be used to mass produce integrated optical elements like the aforementioned gratings. Generally, there is a need for new micro and and/or nano devices that can satisfy the size and weight requirements of the systems in which they are to be integrated while maintaining performance levels of their meso-scale counterparts.

An artificial reality system, such as a head-mounted display (HMD), heads-up display (HUD) system, or a near-eye display (NED), generally includes a display configured to present artificial images that depict objects in a virtual environment. The display may project virtual objects or combine images of real objects with virtual objects, as in augmented reality (AR) applications.

For example, in an AR system, a user may view both images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

One example of an optical see-through AR system may use a waveguide-based optical display, where light of projected images may be coupled into a waveguide (e.g., a substrate), propagate within the waveguide, and be coupled out of the waveguide at different locations. In some implementations, the light of the projected images may be coupled into or out of the waveguide using a diffractive optical element, such as a straight or slanted surface-relief grating (SRG).

The parameters of the SRG, such as the grating period, duty cycle, depth, slant angle, refractive index modulation, and the number of multiplexed gratings may need to be tuned and may need to vary individually or in combination across the area of the surface-relief grating, to achieve the desired performance. Fabricating surface-relief gratings with the desired grating parameters at a high fabrication speed and high yield remains a challenging task.

### SUMMARY OF THE DISCLOSURE

The embodiments featured herein help solve or mitigate the above noted issues as well as other issues known in the art. For example, one embodiment provides a method that includes depositing a plurality of layers on a substrate including a pattern. The plurality of layers can form a stack that includes at least two different materials. The stack forms a composite layer which has an effective index of refraction that is unique. The method may make use of at least two different materials, which can be a combination of aluminum oxide (Al2O3), titanium dioxide (TiO2), and silicon dioxide (SiO2). These materials may be deposited via atomic layer deposition (ALD).

Another embodiment provides a surface relief grating that includes a composite layer having a unique effective index of refraction. The composite layer fills a plurality of gaps in the grating. The composite layer may be made of alternating layers of at least two materials where the at least two materials have distinct nominal indices of refraction. Furthermore, the optical loss in the composite layer resulting from either interference or absorption may be less than about 0.1% at a predetermined wavelength range.

In yet another embodiment, there is provided a method that includes depositing alternating layers of at least two materials to form a composite stack, the at least two materials can have distinct indices of refraction. The optical loss in the composite stack resulting from either interference or absorption may be less than about 0.1% at a predetermined wavelength range. This composite stack may be deposited on a substrate that has one or more pattern thereon.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided herein.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an exemplary near-eye display (NED) augmented reality (AR) system in which embodiments of the present disclosure can be practiced.

FIG. 2 illustrates an exemplary waveguide display configured for use in the NED AR system of FIG. 1.

FIG. 3 illustrates an exemplary approach of creating gratings and gap fills in a cross-section of a surface-relief grating (SRG) structure in accordance with the embodiments.

FIG. 4 illustrates an optical device constructed and arranged according to the embodiments.

FIG. 5 illustrates thickness maps of single titanium dioxide and aluminum oxide layers, respectively, each layer being deposited via atomic layer deposition (ALD), according to the embodiments.

FIG. 6 illustrates thickness maps of composite layers including ALD-deposited layers, according to the embodiments.

FIG. 7 illustrates an exemplary computer system upon which aspects of the present disclosure may be implemented.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

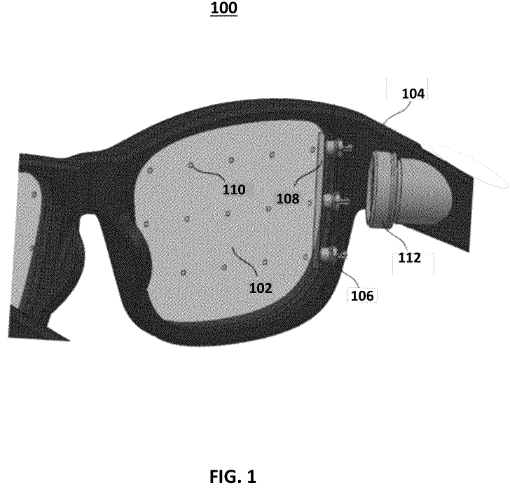

FIG. 1 illustrates an exemplary NED AR display system 100 in which embodiments of the present disclosure can be practiced. The AR display system 100 (e.g., eyeglasses) includes a lens that functions as a display panel 102 attached to eyeglass frame 104. The display panel 102 may comprise transparent display panels, such as waveguide-based display panels, which may function as an eyeglass lens digital overlay. The display panel 102 may also include a substrate that is substantially transparent to visible light and can be used for eye-tracking, such as infrared light. The AR display system 100 includes a light source 106, input couplers 108, output couplers 110, and a camera 112.

The light source 106 may include a light emitting device, such as an LED or a diode laser, that can emit light outside of visible band, such as infrared light. In some embodiments, the light source 106 may also include a lens for collimating or focusing light emitted from the light emitting device. In the embodiments, the light source 106 may be mounted on, or embedded within, the frame 104. Light rays emitted from the light source 106 may be coupled into the substrate of the display panel 102 by the input couplers 108, which may include, for example, a prism, a wedge, a slanted surface, or a grating.

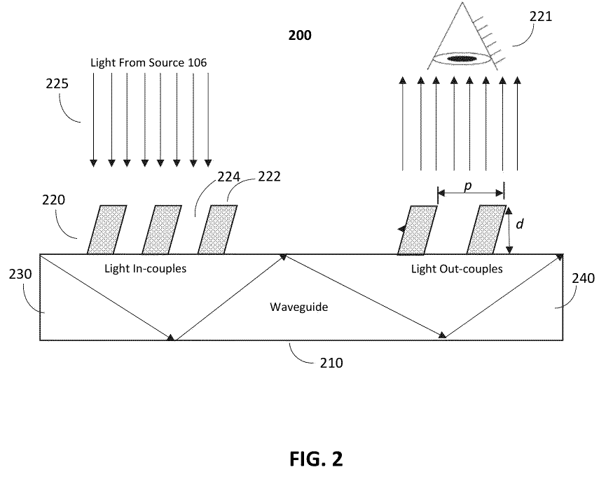

FIG. 2 illustrates an example of a waveguide display 200 configured for use within the display panel 102 of FIG. 1. The waveguide display 200 includes waveguide 210 (i.e., a substrate) having reflective gratings 220 formed thereon. The gratings 220 represent only one section of the gratings within the display panel 102 of FIG. 1. The reflective gratings 220, known as SRGs, form the output couplers 110 in FIG. 1. During operation, the gratings 220 function as a grating coupler for coupling light into or out of the waveguide 210 toward a user’s eye 221, or an eye box.

For example, grating 220 may include a plurality of ridges 222 and grooves 224 between the ridges 222. Each period of grating 220 may include a ridge 222 and a groove 224, which may be an air gap, or a region filled (i.e., gap filled) with a material with a refractive index n_{g2}. The ratio between a width (d) of a ridge 222 and a grating period (p) may be referred to as duty cycle.

During operation, light rays 225 emitted from the source 106 in-couple to the waveguide 210 near a side 230. As the light rays 225 in-couple, the rays bounce along surfaces of the gratings 220 as they are guided into the glass or substrate of the waveguide 210. The light rays 225 travel through, and then out-couple from, the waveguide 210 on a side 240, to the user’s eye 221. Embodiments of the present disclosure are capable of enhancing the speed at which the light travels through the waveguide 210, as explained in greater detail in the discussion below. As known in the art, the speed at which the light travels through the substrate is a function of the wavelength of the light and a refractive index of the substrate.

By way of background, gratings in conventional systems may be created using many different materials and types of materials. For example, the ridges 222 may be made of a material with a refractive index of n_{g1}, such as silicon containing materials (e.g., SiO2, S3N4, or amorphous silicon), organic materials (e.g., spin on carbon, or amorphous carbon layer etc.), diamond like carbon or inorganic metal oxide layers. In these conventional systems, the grooves 224 between the ridges 222 may be overcoated or filled with a material having a refractive index n_{g2}, higher or lower than the refractive index of the material of ridges 222. For example, some conventional systems have a high refractive index material, such as Hafnia, Titania, Tantalum oxide, Tungsten oxide, and the like that may be used as gap fill for the grooves 224.

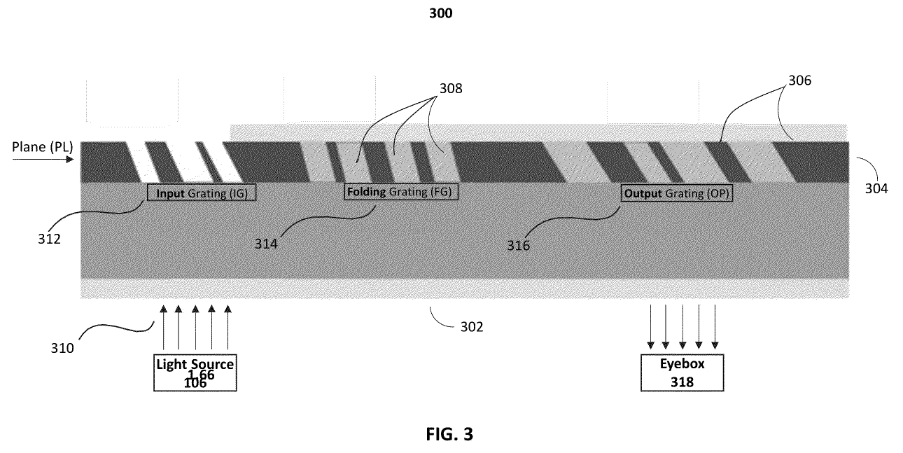

In the embodiments, gratings are created using a unique approach unique. For example, one approach provides substrate gratings having targeted refractive indices that may control or enhance the speed at which the light travels through the substrate. That is, embodiments of the present disclosure facilitate the creation of gratings having different sections respectively formed from multiple permutations and combinations of composite materials with different refractive indices. FIG. 3 illustrates a cross section of exemplary waveguide display 300, having different refractive indices, in accordance with the embodiments.

FIG. 3 illustrates a cross section of an exemplary waveguide display 300 of an imprinted SRG structure. The waveguide display 300, created using the methods and systems described herein, demonstrates the production and flow of light rays through a lens of the AR display system 100. In FIG. 3, gratings 304 include ridge areas (i.e., dark shaded), such as ridges 306 and groove areas (i.e., light shaded), such as grooves 308. In the embodiments, the grooves 308 will be gap filled to create the desired refractive indices. By way of example only, and not limitation, the ridges 306 are constructed with a first refractive index value. The grooves 308, by way of gap fill, are constructed with a second refractive index of value. In the embodiments, through application of ALD, a target or desired refractive index can be produced, by using different materials, based upon desired optical characteristics.

For example, when light rays 310 are projected by the light source 106, the light rays 310 are in-coupled to the waveguide 302 to an input grating section 312 of the grating 304. The light rays 310 flow into the input grating section 312, across a plane (PL) of the waveguide 302, and through a folding grating section 314. The light rays 310 then out-couple through an output grating section 316 to an eye box 318 (effective space where a viewable image is formed by systems lens - size based upon mechanical adjustments of the combiner), representative of the user’s eye (e.g., the eye 221).

The features illustrated in the exemplary embodiment of FIG. 3 are applicable to an entire surface of the grating 304 and provide selectivity. Additionally, in accordance with the embodiments, a grating can be created at any location along a surface of the waveguide 302. By way of example, a grating may be created near one end of the waveguide 302, and with a block mask, a completely different grating can be created at an opposite end of the waveguide 302. The embodiments also provide an ability to create any desired gap fill. By comparison, conventional materials or processes may impose limits (e.g., the ability of coating a surface of a grating) on aspect ratios. In the embodiments, however, since ALD materials are used, no such limits are imposed.

The user experience with an AR display system may depend on several optical characteristics of the system, such as the field of view (FOV), image quality (e.g., resolution), size of the eye box, optical bandwidth, and brightness of the displayed image. In general, the FOV and the eye box need to be as large as possible to cover the visible band. The brightness of the displayed image needs to be sufficiently high (especially for optical see-through AR systems).

By way of example, in a waveguide-based NED, such as the AR display system 100, the output area of the display is usually much larger than the size of the NED system’s eye box. The portion of light that may reach a user’s eye may depend on the ratio between the size of the eye box and the output area of the display.

As understood by those of skill in the art, substrate refractive index is an important metric the market of AR and mixed reality (MR) diffractive waveguides for wearable devices. For example, a higher refractive index substrate will generally improve optical clarity and provide for a wider FOV. Refractive indices, however, are largely an inherent characteristic of the optical transmission substrate. Therefore, obtaining significant improvements in refractive indices can be difficult using conventional approaches. A similarly difficult task is designing a waveguide to desirable or specific refractive index.

The embodiments described herein provide solutions to these, and other, AR/VR waveguide fabrication challenges. Through experimentation, the embodiments provide exemplary optimal combinations of materials in an ALD process to fabricate AR waveguide gratings to meet a specified refractive index.

By way of example and not limitation, ALD is used in the embodiments to gap fill gratings at an angle from about 0-60 degrees by combining materials at different ratios. Films with different indices can be stacked together to achieve target refractive indices. Table 1 below provides refractive indices for single layer and multiple layer materials. By using different materials, and different ratios, selectable refractive indices are achievable within the ranges shown.

Table 1

| | Material | Refractive Index |
|---|---|---|
| 1. | SiO2 | 1.46 |
| 2. | Al203 | 1.77 |
| 3. | TiO2 | 2.3 |
| 4. | AL203/TiO2 | 1.77 - 2.4 |
| 5. | SiO2/Al203 | 1.44 - 1.77 |
| 6. | SiO2/TiO2 | 1.44 - 2.4 |

Specifically, in Table 1, rows 1-3 contain refractive indices for single layer materials. Rows 4-6 include the range of refractive indices for combinations of materials, stacked together, and having different ratios.

Consider the example of creating a waveguide having a specified refractive index value of 2.05. Using a single layer material (Table 1 rows 1-3), the specified refractive index value of 2.05 is not achievable. To reduce a refractive index value of 2.05, in accordance with the embodiments, the exemplary combinations of composite materials shown at Table 1, rows 4-6, may be used with an ALD process. The embodiments use different ratios of materials with ALD to facilitate creation of gratings at a needed or desired refractive index.

In Table 1, row 4, a specified effective refractive index value can be between about 1.77 and 2.4 using a combination of silicon dioxide (SiO2) and aluminum oxide (Al2O3) materials stacked together. In row 5, the unique effective refractive index value can be between 1.44 and 1.77 using a combination of silicon dioxide (SiO2) and aluminum oxide (Al2O3) materials stacked together. In row 6, the unique effective refractive index value can be between 1.44 and 2.4 using a combination of silicon dioxide (SiO2) and aluminum oxide (Al2O3) materials stacked together. Each of these material combinations may include depositing on features/topography that have an angle respective to the substrate that is from about 0 - 60 degrees.

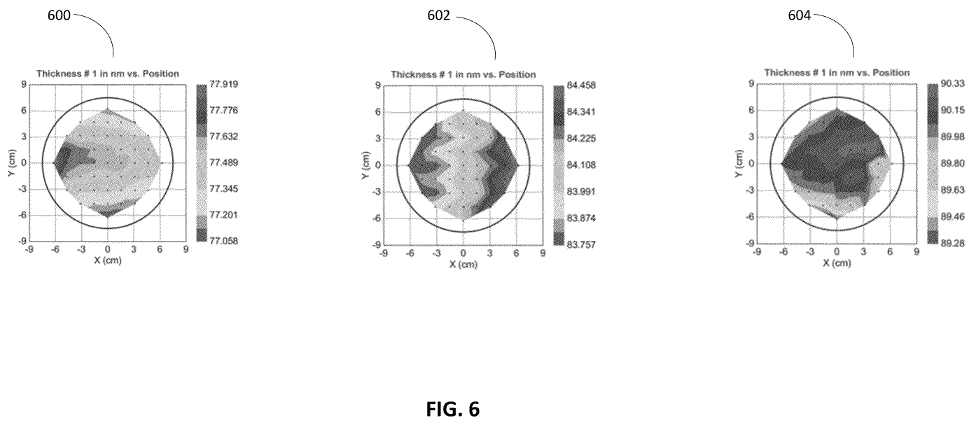

In the embodiments, the layers of composite layers of materials described herein may be constructed in a manner such that the absorption of each layer is effectively zero. For example, as the light in-couples through the gratings, absorption occurs each time it touches an interface (e.g., between layers of the substrate). The embodiments may limit the absorption by limiting the number of interfaces. The effects of these methods and systems are illustrated more fully below, in relation to FIG. 6. In the embodiments, by changing the number of interfaces (i.e., cycles), absorption can be improved.

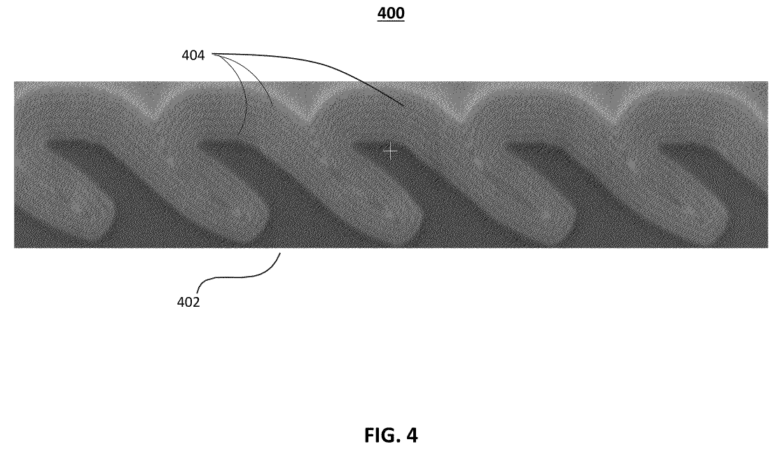

FIG. 4 illustrates an optical device 400 constructed in accordance with the embodiment. By way of example, the optical device 400 is an SRG and includes gratings 402. Fabrication of the optical device 400 may begin with forming a pattern, or series of lines in the substrate, such as lines 404. For example, the pattern may be formed utilizing a subtractive fabrication process. Each of the lines 404 represents a material layer and corresponds to a cycle within the ALD process. Each of the lines 404 corresponds to a groove formed directly within a bulk of the substrate. Without limitation and by example only, the substrate may be glass or a plastic material such as an acrylic polymer like polymethyl-methacrylate (PMMA).

The subtractive process may be a laser machining process, an ion milling process, or generally, it may be a dry subtractive manufacturing process, a wet subtractive manufacturing process, or a combination of the two. Further, one of skill in the art will readily recognize that selection of a fabrication method for forming the pattern can be dictated by the material in which the SRG is to be formed and by the resolution achievable by the process in relation to the desired optical performance of the SRG.

Furthermore, one of skill in the art will readily understand that the aforementioned subtractive process may be tuned to achieve line width, depth, and/or spacing as well as a number of lines that impart a desired optical performance to the resulting device. For example, parameters such as line width, depth, spacing, or number of lines may each or all be optimized to impart a reflectance characteristic to the optical device 100 at a predetermined center wavelength.

Furthermore, these parameters may also be optimized to ensure transmission in a desired band of wavelengths. As an example, a SRG as fabricated by the method described above may be configured to have a center wavelength at about 460 nm. The full-width-half-max (FWHM) for a band of wavelengths that are to be reflected by the SRG may also be tuned by optimizing the aforementioned parameters.

In an exemplary embodiment consistent with the novel teachings presented herein, the fabrication of an optical device, such as the AR display system 100, may further include conducting a gap fill process to further tune the optical characteristics of the system. This gap fill process may be an additive manufacturing process that is configured to fill the gaps resulting from the previous step of forming the lines within the bulk of the substrate.

In this exemplary embodiment, the gap fill process may be achieved using ALD, which is a thin film deposition process that is based on the sequential use of gas phase chemical processes. For example, an ALD process may include a plurality of reactants or precursors that interact with a surface in a temporally sequential manner. A thin film may thus be deposited on the surface in a self-limiting manner.

The ALD process may be configured to produce a plurality of layers that fill the gaps of the SRG. The plurality of layers can form a stack of layers made from at least two different materials. Each of the two different materials may have different nominal refractive indices. However, when put together to form a stack, the resulting composite layer has an effective refractive that is unique, i.e., a single refractive index.

As such, contrary to Bragg filters or interference stacks made with layers of alternating dielectrics having different refractive indices, the exemplary stack does not exhibit substantial interference or absorption. For example, and not by limitation, absorption or interference in the exemplary stack made by ALD may be less than about 1%, less than about 0.5%, or less than about 0.1%, in various implementations of the gap fill process.

Therefore, the resulting composite layer functions as a single layer having a unique effective refractive index even though it is made of alternating layers of materials having different indices of refraction.

In an exemplary embodiment, the composite layer may be deposited via ALD over topographies that includes features making an angle with a horizontal plane. This angle may be from about 0 degrees to about 60 degrees. One of ordinary skill in the art will readily understanding that this range of angles can impart a desired optical performance to the SRG, as is known in the art. Generally, however, the method of fabrication of the composite described above can be applied to any topography, i.e., to substrates that have angles that are greater than 60 degrees. For example, since ALD is highly conformal process, steep sidewalls (e.g., at 90 degrees to the horizontal plane) can also be coated with the exemplary method of fabricating the composite layer.

To achieve the exemplary composite layer, cycles of the ALD process may include a precursor which allows transfer of atoms between precursor vapors and surfaces. Volume of precursor is controlled by pulsating at a stable pressure and time. Precursor reacts and bonds to the surface without fully decomposing in turn changing the surface termination. Following that reactant is introduced in the chamber for second half of the reaction. Post each half cycle the vapor products are pushed out using purge step which again is controlled by time.

One of ordinary skill in the art will readily understand that this recipe or process sequence is exemplary and that tuning the process to achieve a desired result (i.e., a given thickness per layer) may be tool-dependent. As is known in the art, a recipe can be calibrated for a given tool to achieve a targeted thickness repeatably and within a predetermined acceptable tolerance. Such process engineering and calibration may be achieved without undue experimentation.

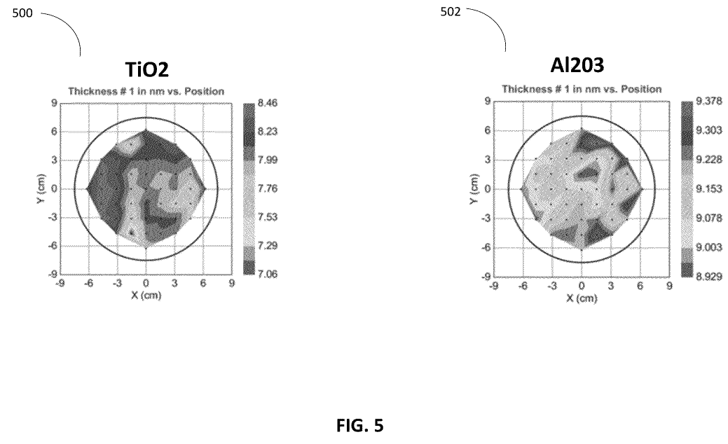

FIG. 5 illustrates exemplary thickness maps of a single titanium dioxide (TiO2) layer 500 and a single aluminum oxide (Al203) layer 502. Each of the layers 500 and 502 was deposited via an ALD process.

FIG. 6 illustrates exemplary composite ALD-deposited layers 600, 602, and 604. The layers 600, 602, and 604 provide exemplary effective refractive indices. In addition to depicting effective refractive indices, FIG. 6 illustrates effects of being able to gap fill at any desired refractive index value. That is, the embodiments provide the ability to create functional gratings using combinations of stacked materials.

Further, functional gratings created using the methods described herein are SRGs and may be used as operational or functional waveguides in AR/VR/MR waveguide applications. Functional gratings used herein also reduce absorption of each of the material layers to effectively zero. By changing the number of interfaces, or cycles, improvements in absorption can be obtained.

In the embodiments, the following features work together to enhance absorption performance: (a) the manner in which SRGs are fabricated, (b) the capability of constructing waveguides to achieve any refractive index, and (c) the ability to choose various permutations and combinations of various materials in fabricating the SRGs. More specifically, the features (a) - (c) provide an ability to control the refractive index. Controlling the refractive index contributes facilitates control and enhancement of the absorption performance.

FIG. 6 depicts the different number of cycles (and interfaces) that control absorption and effectively achieve different refractive indices. In particular, the shading in the layers 600, 602, and 604 shows uniformity in the thickness, and minimal variance, throughout the composite layer material(s). This process is fundamental to controlling flow, cycles, and interfaces.

For example, in the layers 600, 602, and 604 of FIG. 6, there is minimal variance in uniformity over wide areas (e.g., on the order of centimeters (cm)). It is known in the art that films, when deposited, are not purely atomically flat. However, in the exemplary illustrations of FIG. 6, for a wide area of about 3 cm × 3 cm (about a 6 cm radius), variations in thickness are minimal. For example, the thickness variations over the regions depicted in the layers 600, 602, and 604 of FIG. 6 are less than about two nanometers (nm).

Generally, the embodiments provided herein include SRGs and methods of making the same. For example, one embodiment provides a method that includes depositing a plurality of layers in a substrate including a pattern. The plurality of layers can form a stack that includes at least two different materials. The stack thus forms a composite layer which has an effective index of refraction that is unique. The method may make use of at least two different materials, which can be a combination of aluminum oxide (Al2O3), titanium Dioxide (TiO2), and silicon dioxide (SiO2). These materials may be deposited via ALD.

The method described above may be used to make a surface relief grating. This surface relief grating may include a substrate having a pattern machined thereon. The pattern may have a plurality of gaps. The surface relief grating may have a composite layer that has a unique effective index of refraction filling the plurality of gaps. The composite layer may be made of alternating layers of at least two materials, where the at least two materials have distinct nominal indices of refraction. Furthermore, the optical loss in the composite layer resulting from either interference or absorption may be less than about 1% at a predetermined wavelength range, i.e., it may be negligible or substantially negligible.

While the above embodiments are described in the context of making a surface relief grating, the exemplary method may generally be applicable to other optical devices or micro/nano-fabricated devices. Specifically, an exemplary method can include depositing alternating layers of at least two materials to form a composite stack, the at least two materials having distinct indices of refraction.

The optical loss in the composite stack resulting from either interference or absorption may be less than about 1% at a predetermined wavelength range. This composite stack may be deposited on a substrate that have one or more pattern thereon. The one or more patterns may be bulk-machined or surface-machined, using micro or nano-fabrication methods known in the art. Furthermore, while specific materials have been described in the context of the disclosure, one of ordinary skill in the art will readily recognize that other materials and/or material systems can be used without departing from the scope of the present disclosure.

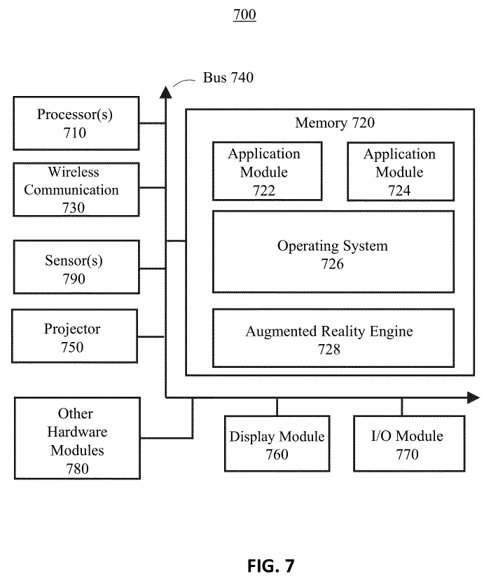

FIG. 7 is a simplified block diagram of an example computer system 700 of an example NED (e.g., HMD device) for implementing aspects of the embodiments disclosed herein. In this example, the computer system 700 may include one or more processor(s) 710 and a memory 720.

The processor(s) 710 may be configured to execute instructions for performing operations at a number of components. The processors(s) 710 can be, for example, a processor or microprocessor suitable for implementation within a portable electronic device. The processor(s) 710 may be communicatively coupled with a plurality of components within the computer system 700. To realize this communicative coupling, processor(s) 710 may communicate with the other illustrated components across a bus 740. The bus 740 may be any subsystem adapted to transfer data within the computer system 700.

The memory 720 may be coupled to processor(s) 710. The memory 720 may be volatile, such as static random access memory (SRAM) and/or dynamic random access memory (DRAM) and/or non-volatile, such as read-only memory (ROM), flash memory, and the like. The memory 720 may provide storage of computer-readable instructions, data structures, program modules, and other data for the computer system 700. A set of instructions and/or code might be stored on the memory 720. The instructions might take the form of executable code that may be executable by the computer system 700.

In some embodiments, the memory 720 may store a plurality of application modules 722 - 724, which may include any number of applications. By way of example, the applications may include a depth sensing function or eye tracking function. Application modules 722-724 may include instructions to be executed by processor(s) 710. In some embodiments, certain applications, or parts of application modules 722-724 may be executable by other hardware modules 780.

In some embodiments, memory 720 may include an operating system 726 loaded therein. The operating system 726 may be operable to initiate execution of the instructions provided by application modules 722-724 and/or manage other hardware modules 780 as well as interfaces with a wireless communication subsystem 730 which may include one or more wireless transceivers.

A wireless communication subsystem 730 may include, for example, an infrared communication device, a wireless communication device and/or chipset (such as a Bluetooth device, an IEEE 802.11 device, a Wi-Fi device, cellular communication facilities, etc.), and/or similar communication interfaces. The wireless communications subsystem 730 may permit data to be exchanged with a network, other computer systems, and/or any other devices described herein.

Embodiments of the computer system 700 may also include one or more sensors 790. Sensor(s) 790 may include, for example, an image sensor, an accelerometer, a pressure sensor, a temperature sensor, a proximity sensor, an ambient light sensor, or any other similar module to provide sensory output and/or receive sensory input, such as a depth sensor or a position sensor. For example, in some implementations, sensor(s) 790 may include one or more inertial measurement units (IMUs) and/or one or more position sensors.

An IMU may generate calibration data indicating an estimated position of the HMD device relative to an initial position of the HMD device, based on measurement signals received from one or more of the position sensors. A position sensor may generate one or more measurement signals in response to motion of the HMD device. At least some sensors may use a structured light pattern for sensing.

The computer system 700 may include a display module 760. Display module 760 may be a NED, and may graphically present information, such as images, videos, and various instructions, from the computer system 700 to a user. Such information may be derived from one or more application modules 722-724, virtual reality engine 728, one or more other hardware modules 780, a combination thereof, or any other suitable means for resolving graphical content for the user (e.g., by operating system 726).

The computer system 700 may include a user input/output (I/O) module 770. The I/O module 770 may allow a user to send action requests to the computer system 700. In some embodiments, user input/output module 770 may provide haptic feedback to the user in accordance with instructions received from the computer system 700. For example, the haptic feedback may be provided when an action request is received or has been performed.

The computer system 700 may include a camera 750 that may be used to take photos or videos of a user, for example, for tracking the user’s eye position. Camera 750 may also be used to take photos or videos of the environment, for example, for VR, AR, or MR applications. In some implementations, camera 750 may include two or more cameras that may be used to capture 3-D images. In some embodiments, memory 720 of the computer system 700 may also store a virtual reality engine 728.

The virtual reality engine 728 may execute applications within the computer system 700 and receive position information, acceleration information, velocity information, predicted future positions, or some combination thereof of the MR device from the various sensors. In some embodiments, the information received by virtual reality engine 728 may be used for producing a signal (e.g., display instructions) to display module 760. The virtual reality engine 728 may perform an action within an application in response to an action request received from the I/O module 770 and provide feedback to the user. The provided feedback may be visual, audible, or haptic feedback. In some implementations, processor(s) 710 may include one or more GPUs that may execute virtual reality engine 728.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A method of fabricating an optical device, the method comprising:
disposing a plurality of layers in a substrate including a pattern, wherein the plurality of layers forms a stack including two or more materials; and
wherein the stack forms only one composite layer having an effective index of refraction that is unique.

2. The method of claim 1, the disposing includes depositing the plurality of layers via an atomic layer deposition process.

3. The method of claim 1, wherein the at least two different materials are aluminum oxide (Al₂O₃) and titanium dioxide (TiO₂).

4. The method of claim 3, wherein the effective index of refraction of the composite layer is between about 1.77 and about 2.4.

5. The method of claim 1, wherein the at least two different materials are silicon dioxide (SiO₂) and aluminum oxide (Al₂O₃).

6. The method of claim 5, wherein the effective index of refraction of the composite layer is between about 1.44 and about 1.77.

7. The method of claim 1, wherein the at least two different materials are silicon dioxide (SiO₂) and aluminum oxide (Al₂O₃).

8. The method of claim 7, wherein the effective index of refraction of the composite layer is approximately between 1.4 and 2.7.

9. The method of claim 1, wherein the composite layer is substantially free of optical absorption and of optical interference at a center wavelength of the optical device.

10. The method of claim 1, further comprising forming the pattern as a volumetric Bragg grating.

11. The method of claim 1, further comprising disposing the plurality of layers at an angle respective to the substrate that is from about 0 degrees to 60 degrees.

12. A method for fabricating a composite layer, the method comprising:
depositing alternating layers of at least two materials to form a composite stack, the at least two materials having distinct indices of refraction;
wherein the optical loss in the composite stack resulting from either interference or absorption is less than about 1% at a predetermined wavelength range.

13. The method of claim 12, wherein the depositing includes utilizing atomic layer deposition.

14. The method of claim 12, wherein the alternating layers include one of Al₂O₃, TiO₂, and SiO₂.

15. A Surface relief grating (SRG), comprising:
a substrate having a pattern machined thereon, the pattern having a plurality of gaps; and
a composite layer having a unique effective index of refraction filling the plurality of gaps, wherein the material includes alternating layers of at least two materials, the at least two materials having distinct nominal indices of refraction;
wherein the optical loss in the composite layer resulting from either interference or absorption is less than about 1% at a predetermined wavelength range.

16. The SRG of claim 15, wherein the composite layer includes aluminum oxide (Al₂O₃) and titanium dioxide (TiO₂).

17. The SRG of claim 16, wherein the unique effective index of refraction is between about 1.77 and about 2.4.

18. The SRG of claim 15, wherein the composite layer includes silicon dioxide (SiO₂) and aluminum oxide (Al₂O₃).

19. The SRG of claim 18, wherein the unique effective index of refraction is between about 1.44 and about 1.77.

20. The SRG of claim 15, wherein the composite layer includes silicon dioxide (SiO₂) and (Al₂O₃) and wherein the effective index of refraction of the composite layer is between about 1.44 and 2.4.
